(19) United States
(12) Patent Application Publication
(10) Pub. No.: US 2026/0061426 A1
(43) Pub. Date: Mar. 5, 2026

(54) Apparatus for Laboratory Ware

(71) Applicant: Berg Design Limited, Perth (GB)

(72) Inventor: Graham William Rennie, Perth (GB)

(21) Appl. No.: 19/105,809

(22) PCT Filed: Sep. 8, 2023
(86) PCT No.: PCT/EP2023/074752

§ 371 Date: Feb. 23, 2025

(30) Foreign Application Priority Data
Sep. 9, 2022 (GB) 2213251.8
Dec. 17, 2022 (GB) 2219128.2
Jun. 6, 2023 (GB) 2308426.2

(51) Int. Cl. B01L 9/00

(52) U.S. Cl. CPC B01L 9/543; B01L 2300/04; B01L 2300/0832

(57) ABSTRACT

A laboratory ware magazine suitable for holding an array of pipette tips. The magazine is formed as a box which is substantially a sector of a cylinder, with a cylindrical or a polygonal cross section. A mounting plate within the box has apertures to hold the pipette tips directed radially inwards and the box has a lid which may be a removable plastic/foil. The boxes can be combined to form a compact cylindrical assembly for reduced transportation volume, while isolating pipette tips in smaller numbers to reduce the risk of contaminating large numbers of pipette tips found in prior art cylindrical magazines. Mounting receptacles are also described for single box use and for a cylindrical assembly to provide rotation to present each box in turn for use.

The present invention relates to laboratory ware magazines, laboratory ware magazine stacks and laboratory ware dispensers.

Pipette tips are used widely in laboratories. In the laboratory pipette tips are often stored in dispensers that provide protection from contamination whilst allowing for ease of access when the tips are to be put into use. Pipette tip dispensers are normally of rectangular footprint and covered by a lift-off, hinged lid or preferably sliding lid. The typical number of pipette tips found in a box is 96, arranged in an 8×12 matrix. In use, the lid of such a dispenser is slid to one side or the other to allow for the removal of some of the stored pipette tips whilst protecting the other tips from contamination. Removal is by a pipette which may remove a single pipette tip, single channel pipette or remove four, eight or twelve in a linear array at one time, with a 4, 8 or 12 multi-channel pipette.

These known pipette tip dispensers of rectangular footprint take up an area of work surface commensurate with that footprint and, therefore, when a large number of pipette tips are required for use at the same time, for example when robotic pipetting machinery is to be employed, a relatively large footprint area is required to house the pipette tip dispensers. Further, when multi-channel pipettes are used, either manual or automated, the contents of known pipette tip dispensers are emptied relatively rapidly due to the limited pipette tip storage capacity.

WO2007045888 describes a laboratory ware dispenser comprising: a receptacle defining a space; at least one laboratory ware magazine for containing items of laboratory ware and comprising a plurality of apertures; the space defined by the receptacle being configured to receive the laboratory ware magazine; and the receptacle comprising at least one aperture in a surface thereof the aperture being dimensioned such that at least one but not all of the apertures of the laboratory ware magazine are registerable with the aperture of the receptacle upon relative rotation of the receptacle and laboratory ware magazine. The invention further provides a laboratory ware magazine comprising: an annular support member defining a space for containing a plurality of items of laboratory ware; a plurality of apertures arranged around a circumference of the annular support member, each aperture being adapted to receive an item of laboratory ware; and each of said apertures being configured such that an item of laboratory ware placed in the aperture is directed radially inwardly of the annular support member into the space and is retained in the aperture. The invention even further provides a laboratory ware magazine stack comprising a plurality of laboratory ware magazines.

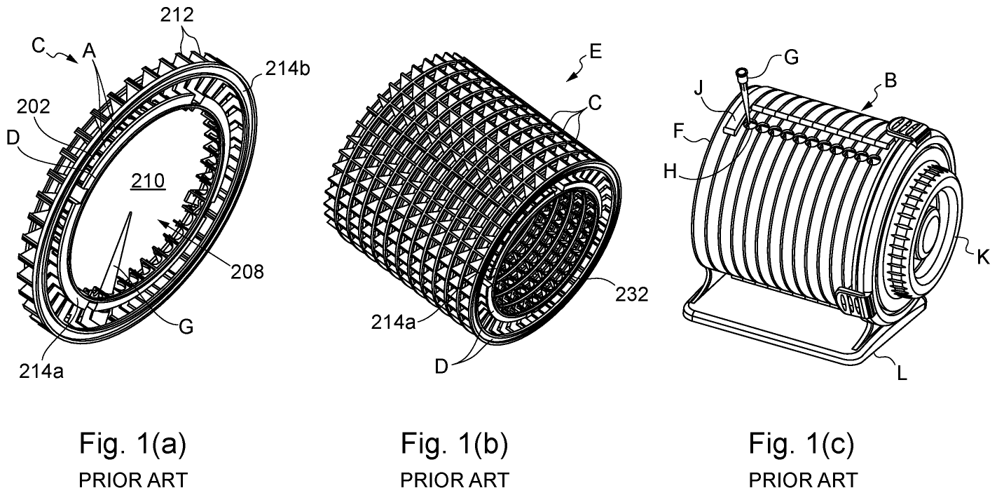

An embodiment of a laboratory ware dispenser of WO2007045888 is shown in FIGS. 1(a)-(c). By arranging the apertures A to face radially inwards, a pipette tip dispenser B formed of circular magazines C, each holding 40 apertures equidistantly spaced around an annular support frame D, can be snapped together to form a cylindrical assembly E, locatable in a cylindrical housing F. Frame D holds the pipette tips G in the apertures A. Housing F provides a linear array of access points H with individual covers J and end caps K so that pipette tips A loaded in the magazines C formed into assembly E, can be stored in sterile conditions. The housing F is formed integrally with a stand L and with the end caps K attached to the assembly E, the assembly can be rotated relative to the housing F, to align an access point H with an aperture A and remove a pipette tip G. Typically 12 magazines C are in the assembly E.

Pipette tip dispenser B advantageously has a footprint for the 480 pipette tips G which is appreciably smaller than that for five of the rectangular pipette tip dispensers needed for the equivalent number of pipette tips. This saves laboratory space. A disadvantage of the dispenser B is that single channel pipettes have limited use. Additionally, if any aperture A becomes contaminated then the entire assembly E of 480 pipette tips must be disposed of.

It is an object of at least one embodiment of the present invention to provide a laboratory ware magazine which obviates or mitigates at least one of the disadvantages of the prior art.

According to an aspect of the present invention there is provided a laboratory ware magazine comprising:
a box being substantially a sector of a cylinder: having first and second end walls being the sector shape enclosed between a perimeter and two radii at either end of that perimeter, first and second rectangular side walls with a width less than or equal to the radii and a length; and
a mounting plate with first and second opposing curved edges at ends of parallel arranged side edges, the plate including an array of apertures therethrough;
each of said apertures being configured such that an item of laboratory ware placed in the aperture is directed radially inwardly towards a tip of the sector.

By providing a box which is a wedge-shaped segment or ‘piece of pie’ shape, these can be combined to form a cylindrical assembly while isolating pipette tips in smaller numbers to reduce the risk of contaminating large numbers of pipette tips. Additionally, the closer packing of the pipette tips means that multiple boxes of pipette tips can be packed and transported in smaller sized containers compared to the prior art pipette tip dispensers.

Preferably the mounting plate is dimensioned to fit in the box. Preferably the apertures are circular. More preferably the apertures are shaped to each hold a pipette tip.

In an embodiment, the perimeter is an arc and the cylinder has a circular cross-section. Alternatively, the perimeter is a chord and the cylinder has a polygonal cross-section.

Preferably, the box includes at least one lid with dimensions matching the perimeter of the end walls and the length of the side walls. The lid may be curved. The lid may be hinged to one of the side walls. Optionally, the lid may be a slide fit to slide over the length of the box to provide an opening space in the box. Alternatively or additionally, the lid may be a flexible member. The flexible member may be a plastic film or metal foil attached to the box. The lid preferably is sealed to the box. In this way, pipette tips in the box are kept from air borne contamination.

Preferably, there are 96 apertures in the mounting plate. More preferably, the apertures are in a rectangular array which may be an 8 by 12 array, with the 12 apertures arranged along the length of the side edges and the 8 apertures arranged along the perimeter of the end walls. They could also be in an 6 by 16 array. In this way, each box can hold the equivalent number of pipette tips as the rectangular dispensers of the prior art. Alternatively there may be 128 or 100 apertures in the mounting plate. These may be in rectangular arrays of 10 by 10 or 8 by 16 array.

In an embodiment, a tip of the sector were the side walls meet, is removed and a rectangular face located between the side walls as a base for the box.

The laboratory ware magazine may include a mounting receptacle, comprising a rectangular member having a base to locate upon a work bench or the like; and a recess shaped to hold the box for all ends of the arcs to be equidistant from a plane of the base. The mounting receptacle may have side walls upon which lobes on the first and second end walls locate. In this way, the laboratory ware magazine can be used in the same manner as the prior art rectangular pipette tip dispensers.

The mounting receptacle may include a rotational mount configured to allow the box to rotate following the path of the arc. In this way, each line of apertures along the length of the box can be arranged to be parallel to the workbench or the like for ease of operation.

Preferably a plurality of boxes are arranged to form a cylindrical assembly. There may be five boxes in a cylindrical assembly with each sector having a 72 degree central angle. Alternatively there may be six boxes with each sector having a 60 degree central angle.

The cylindrical assembly may include end caps which affix to each box at the first and second end walls. The fixing may be at the lobes of the boxes. The end caps may be connected via spindle arranged longitudinally in the centre of the cylindrical assembly.

An outer curved surface of the lid of each box may have angled edges tapering to the side edges. Such angled edges prevent the assembly from rolling as it will sit on angled edges of neighbouring boxes when the cylindrical assembly is arranged with its central axis parallel to a work surface in use.

By having a cylindrical assembly formed of a number of boxes, such a magazine offers a user to locate different pipette tips in each box to allow for variety in a smaller footprint in a lab. It also allows for the easy replacement of a box. It has also been found that whereas the rectangular dispensers referred to as racks (pipette tip boxes) are normally sold to distributers in cases, each case contains 50 racks (4800 pipette tips), only 10 racks are required to provide the same number of pipette tips in the present invention. Further the smaller footprint reduces the size of packaging to a third and consequently shipping costs are greatly reduced.

An assembly receptacle may be included. The assembly receptacle being a substantially rectangular member having a base for locating upon a work surface, and a recess into which the assembly may be located. The recess may have a cylindrical surface for the assembly to be rotated therein. The cylindrical assembly may include an annular lip or ring on the each end, formed of arc sections on each box. The recess may be bounded by end walls onto which the annular lip locates. In this way, the cylindrical assembly may be rotated and repositioned to show a desired box in the uppermost location. For a cylindrical assembly formed with a polygonal cross-section, the recess may have a part polygonal surface for the cylindrical assembly to be located therein, with each side of the polygonal surface matching the perimeter of the boxes, and the recess surface arranged such that ends of the perimeter of an uppermost box are equidistant from the base. In this way, a box of pipette tips is presented to a user.

In the description that follows, the drawings are not necessarily to scale. Certain features of the invention may be shown exaggerated in scale or in somewhat schematic form, and some details of conventional elements may not be shown in the interest of clarity and conciseness. It is to be fully recognized that the different teachings of the embodiments discussed below may be employed separately or in any suitable combination to produce the desired results.

Accordingly, the drawings and descriptions are to be regarded as illustrative in nature, and not as restrictive. Furthermore, the terminology and phraseology used herein is solely used for descriptive purposes and should not be construed as limiting in scope. Use of terms such as “upper” and “lower” are considered relative and though the well bore is drawn in the ideal vertical orientation, it will be appreciated that this may be deviated. Language such as “including,” “comprising,” “having,” “containing,” or “involving,” and variations thereof, is intended to be broad and encompass the subject matter listed thereafter, equivalents, and additional subject matter not recited, and is not intended to exclude other additives, components, integers or steps. Likewise, the term “comprising” is considered synonymous with the terms “including”or “containing”for applicable legal purposes.

All numerical values in this disclosure are understood as being modified by “about”. All singular forms of elements, or any other components described herein including (without limitations) components of the apparatus are understood to include plural forms thereof.

There will now be described, by way of example only, various embodiments of the invention with reference to the drawings, of which:

FIGS. 1(a)-(c) illustrate (a) laboratory ware magazine, (b) cylindrical assembly and (c) laboratory ware dispenser according to the prior art; and

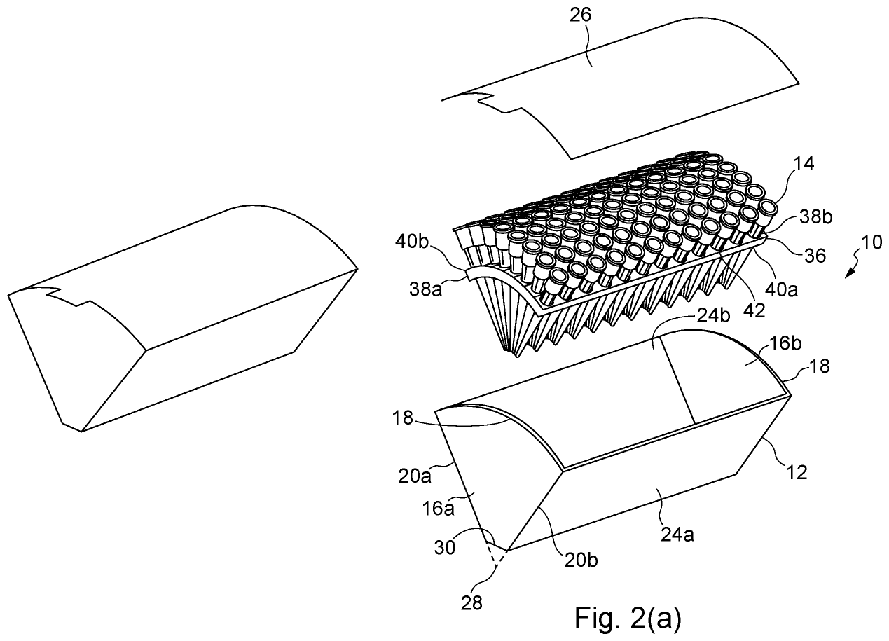

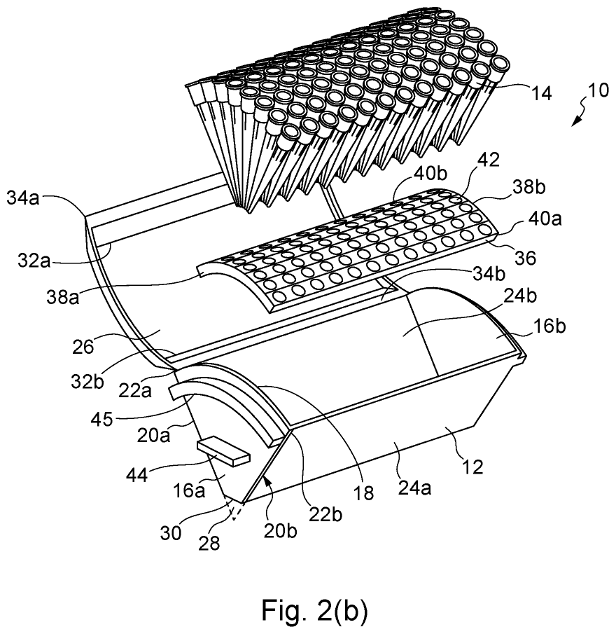

FIGS. 2 to 12 illustrate laboratory ware magazines according to embodiments of the present invention.

Referring initially to FIG. 2(a) there is illustrated a laboratory ware magazine, generally indicated a reference numeral 10, being a wedge-shaped segment with a ‘piece of pie’ shape box 12 for holding laboratory ware 14, according to an embodiment of the present invention. The preferred embodiment holds pipette tips used for transferring liquid samples in laboratories. Such tips come in a range of sizes and may include a filter. Currently 200 μl tips are most commonly used though there is a move towards 10 μl tips as laboratories start to require less liquid for samples. The pipette tips 14 are classically arranged in an 8 by 12 matrix array providing 96 pipette tips. This matches the common rack size provided in rectangular dispensers. The laboratory ware magazine may be considered as a dispensing apparatus.

In the present invention the tips 14 are arranged in a box 12. Box 12 is substantially a sector of a cylinder. Box 12 has first and second end walls 16a, b each being the sector shape enclosed between an arc 18 and two radii 20a, b at either end 22a, b of that arc 20. There are first and second rectangular side walls 24a, b with a width less than or equal to the radii 20a, b and a length between the end walls 16a, b.

In an embodiment, as shown in FIG. 2(a) but not limited thereto, a tip 28 of the sector were the side walls 24a, b meet, is removed and a rectangular face 30 located between the side walls 24a, b as a base for the box 12.

Located inside the box 12, but illustrated outside in FIG. 2(a), is a mounting plate 36. Plate 36 has a similar curved shape to lid 26 with opposing arc edges 38a, b at ends of parallel arranged side edges 40a, b. The plate holds an array of apertures 42. Each aperture 42 is sized to hold a pipette tip 14 with the tips 14 being directly radially inwards, to point towards the sector tip 28, and fit within the segment shaped box 12. The array of apertures 42 matches the 8×12 matrix found in prior art rectangular dispensers.

A lid 26 completes the box 12. The lid 26 is curved to match the arc 18 of the end walls 16a, b and has a length equal to the side walls 24a, b.

In the embodiment shown in FIG. 2(a) the lid 26 is a plastic film or metal foil. This is sealed to the edges of the box 12 so that the lid 26 provides a substantially sealed unit which can be sterilised and kept free from air borne contamination. The lid 26 can include a tab 27 of the same or other material to assist in removal of the lid 26 when access to the pipette tips 14 is required.

Referring now to FIG. 2(b), the magazine 10 is shown with additional features. Like parts are given the same reference numeral to aid clarity. In FIG. 2(b) the lid 26 is now shown as a rigid construction which may be in addition to or an alternative to the plastic film/metal foil lid in FIG. 2(a). In this embodiment, the lid 26 is affixed to the box 12 by either a hinge to one of the side walls 24b or configured as a slide fit over the length of the box 12.

In an embodiment, also shown in FIG. 2(b) but not limited thereto, the outer curved surface of the lid 26 has angled edges 32a, b tapering to the side edges 34a, b which meet the side walls 24a, b of the box 12.

Also shown on the box 12 are the optional features of a lobe 44 located on the end wall 16a. There is also one on the end wall 16b but this is not shown in the figure. A further arc shaped lip 45 is also shown located on the end wall 16a. These features are also on the end wall 16b but this is not shown in the figure.

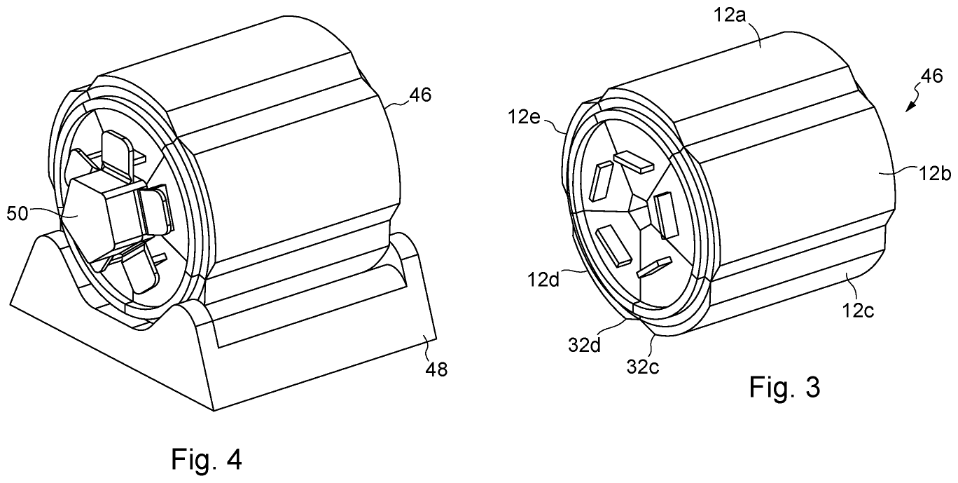

Referring now to FIG. 3 there is illustrated a cylindrical assembly 46. Assembly 46 comprises five boxes 12a-e or magazines, but could have six or any number. When there are five boxes 12a-e each sector is a 72 degree arc. In an embodiment each box 12a-e will contain ninety-six tips 14 providing 480 tips which is the standard number supplied in a rectangular dispenser of the prior art. Alternatively there may be six boxes with each sector being 60 degree arc. These six boxes may have 80 tips in each to make up the 480. Assembly 46 provides all the advantages in terms of the footprint of WO2007045888 (shown in FIGS. 1(a)-(c)), which is incorporated herein by reference, while also containing the tips 14 in batches of 480 so that if contamination became an issue, a single box can be removed and the remaining boxes together with their pipette tips 14 are still useable. This reduces waste and saves money as replacement boxes can be supplied separately but can be packaged for transit in the cylindrical assembly 46. It has also been found that whereas the rectangular dispensers referred to as racks (pipette tip boxes) are normally sold to distributers in cases, each case contains 50 racks (4800 pipette tips), only 10 racks are required to provide the same number of pipette tips in the present invention. Further the smaller footprint reduces the size of packaging to a third and consequently shipping costs are greatly reduced.

It is seen, in use, that the cylindrical assembly 46 is placed on its cylindrical side. In WO2007045888 such a magazine would roll across a bench and need to be held in place. For the cylindrical assembly 46, it will rest on the edges 32c, d which will prevent it from rolling. However, in use, a stand or receptacle 48 is used to hold it. The complete system is shown in FIG. 4.

In FIG. 4, end caps 50 (only one shown) are arranged at each end of the cylinder assembly 46 to hold the boxes 12a-e together in the stand 48. Unlike the embodiment in FIG. 1(a)-(c), the stand is a separate piece which saves space on packaging and cost as only the boxes need to be replaced compared to the housing and integral stand in the prior art of WO2007045888.

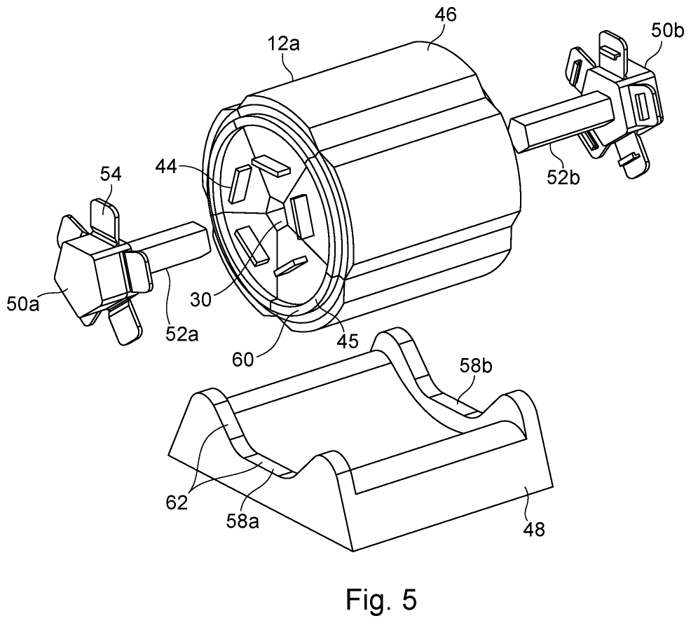

Referring to FIG. 5, an exploded view of FIG. 4 is shown. In this embodiment, the end caps 50a, b have a spindle 52a, b. The spindles 52a, b are multi-faceted to match the base faces 30 of the boxes 12 in which the sector tips 28 have been removed. This ensures that if either end cap 50a, b is rotated the entire assembly 46 will rotate. Such rotation places a fresh box at the apex for opening of the lid 26 and ease of access to the pipette tips 14. The end caps 50a, b include a plurality of clips 54 matching the number of lobes 44 on the end walls 16a, b of the boxes 12 in the assembly 46. By clipping the clips 54 to the lobes 44, the spindles 52a, b and all the boxes 12a-e are held relative to each other.

The stand 48 has a recess 56 into which the assembly 46 is located. The recess 56 has a cylindrical surface for the assembly to be rotated therein. The recess 56 is bounded by end walls 58a, b onto which an annular lip 60 formed from the arc lip sections 45 on each box 12 locates. In this way, the cylindrical assembly 46 may be rotated and repositioned to show a desired box 12a in the uppermost location. The walls 58a, b may be shaped to prevent free rotation of the assembly 46 by having flat portions 62.

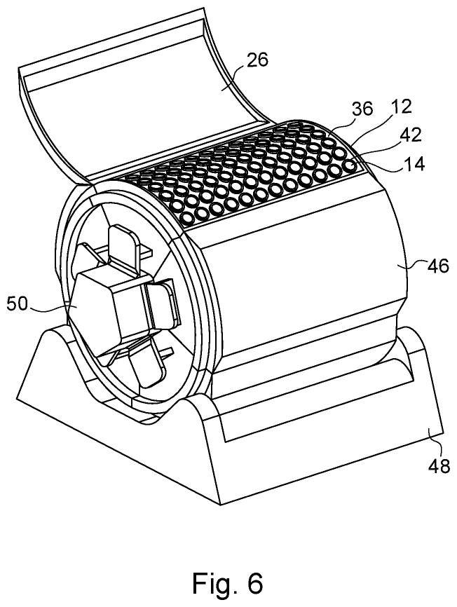

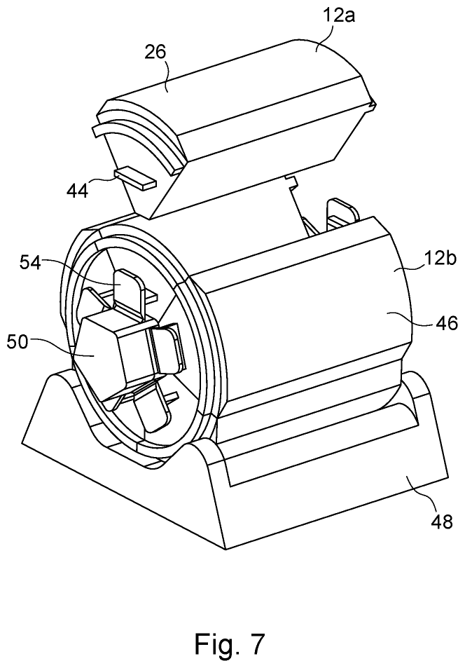

FIG. 6 illustrates the system with a box 12 open so that the pipette tips 14 can be accessed in the apertures 42. While a hinged lid 26 is shown, this could also be a sliding lid.

FIG. 7 illustrates a single box 12a being removed from the assembly 46. This is achieved by releasing the slips 54 from the lobes 44. With the lid 26 closed, the box 12a can be disposed or recycled. As any box can be replaced, boxes containing different pipette tips 14 could be used in the same system to save laboratory space.

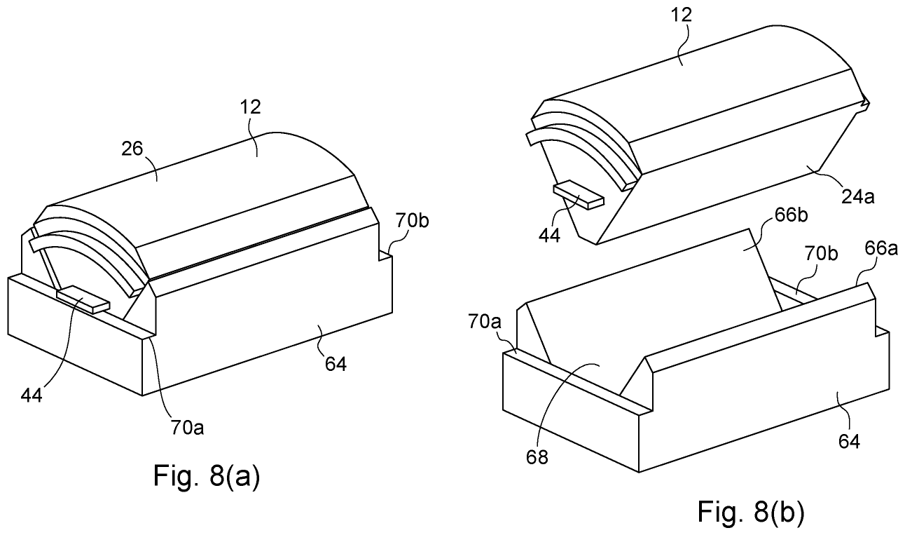

An embodiment of a mounting receptacle 64 for a single box 12a is shown in FIG. 8(a) and (b) with the box 12a inside and outside the receptacle 64. Receptacle 64 has a V-shaped recess 68 with walls 66a, b at the same sector angle as those of the box 12a so that side walls 24a, b rest against the walls 66a, b. A length of the recess also matches the length of the side walls 24a, b so that the lobes 44 can rest against optional end supports 70a, b. When in place, the lid 26 can be opened and the single box 12a used in the equivalent way to the traditional rectangular pipette tip dispenser boxes.

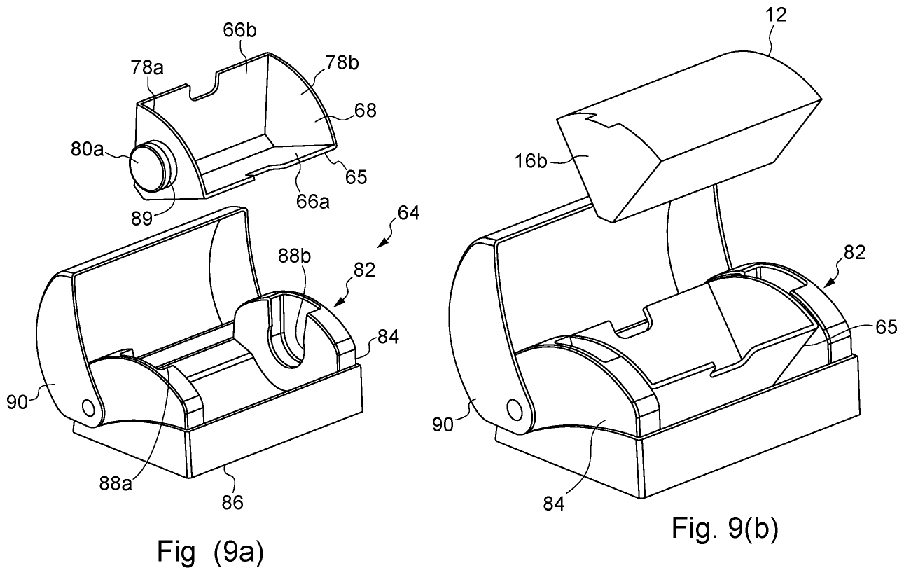

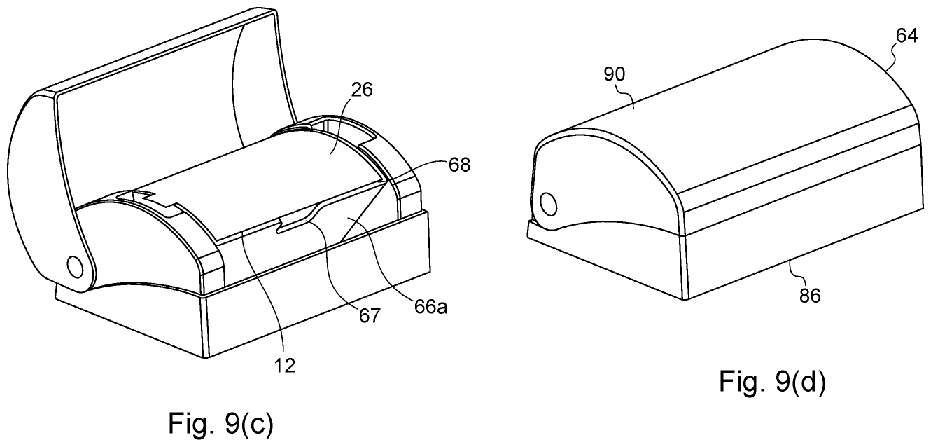

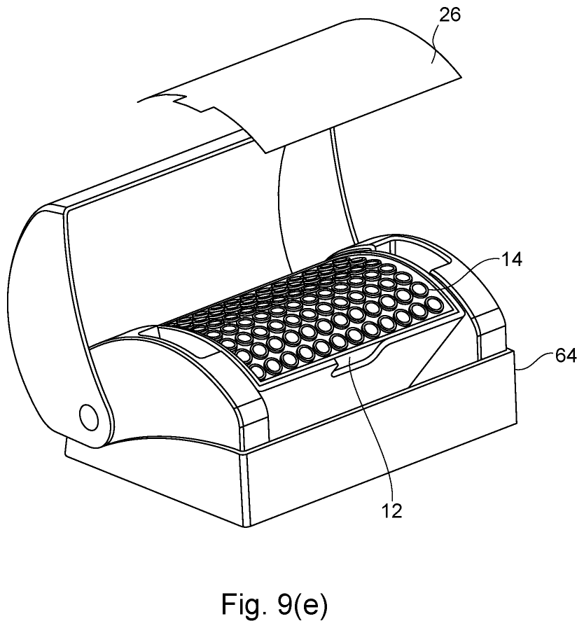

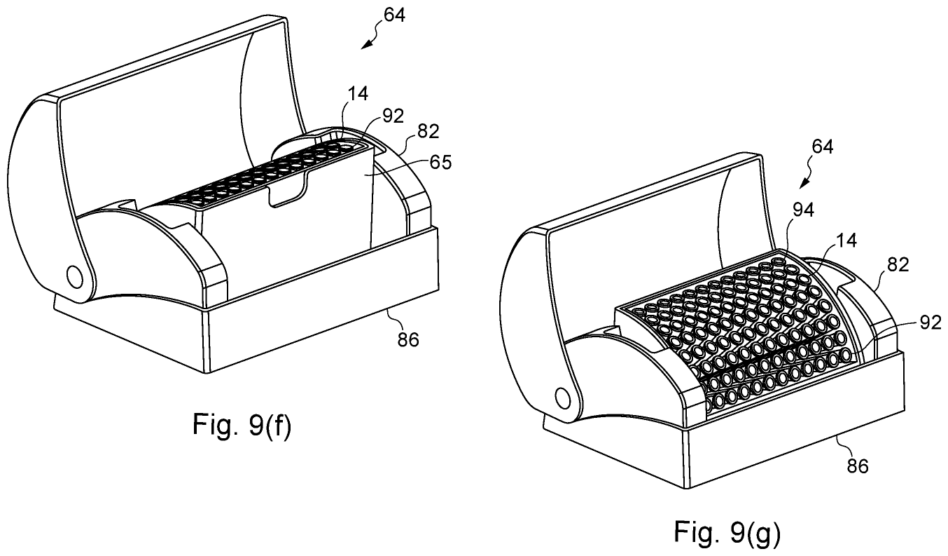

An alternative embodiment of a mounting receptacle 64 for a single box 12 is shown in FIG. 9(a) to (g). This is most suited to the embodiment of the box 12 shown in FIG. 2(a). A first receptacle 65 has a V-shaped recess 68 with walls 66a, b at the same sector angle as those of the box 12a so that side walls 24a, b rest against the walls 66a, b and have an edge matching the arc 18. A length of the recess also matches the length of the side walls 24a, b. End walls 78a, b match the end walls 16a, b of the box 12 so that the box 12 is a snug fit in the first receptacle 65. On the outside of the end walls 78a, b is a pivot 80a, b being part of a rotational mount 82. A second receptacle 84 in the form of a box 84 with a base 86 to be placed on a work bench or the like, includes the bearing 88a, b for the pivot 80a, b. The mount 82 allows the first receptacle 65 to rotate following the arc 18 of the box 12. A frictional contact 89 can be provided so that the first receptacle 65 can sit at any rotational angle to the base 86.

The mounting receptacle 64 may include its own lid 90 which can be used to provide a cover to the pipette tips 14 when the plastic/metal lid 26 is removed.

In use, the first receptacle 65 is located in the second receptacle 84 upon the rotational mount 82, FIG. 9(b), and a box 12 is located in recess 68, FIG. 9(c). The side walls 66a, b can include indents 67 to assist in the placement and removal of a box 12. As shown in FIG. 9(d), a lid 90 can close the mounting receptacle 64 for storage and to keep the box 12 contaminant free. Removal of the box lid 26 provides access to the pipette tips 14, FIG. 9(e).

By rotation of the first receptacle 65 in the mount 82, a first row 92 of pipette tips 14 can be aligned to be parallel to the base 86 and so lie horizontally for easy access for multi-channel pipettes, FIG. 9(f). The first receptacle 65 can be readjusted in the rotational mount 82 to position a further row 94 of pipette tips 14 to be arranged horizontally to the base 86. FIG. 9(g). It will be apparent that the box 12 can be removed and replaced, and the mounting receptacle 64 can be re-used.

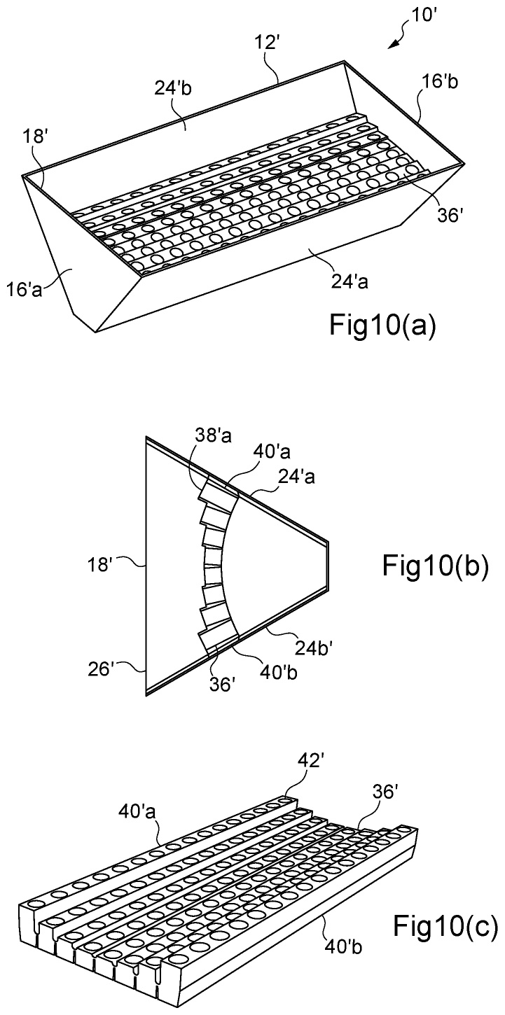

Referring now to FIG. 10(a)-(c) there is illustrated an alternative embodiment of a laboratory ware magazine 10′. Magazine 10′ is shown for holding an 8×16 matrix of pipette tips 14′ but could be formed to hold any number of pipette tips 14′. Box 12′ is similar to box 12, in FIG. 2, with the exception that the permitter, arc 18 in box 12, is now a chord 18′. This allows a rectangular planar lid 26′ to be used on the box 12′. In this way, plastic or metal foil lids 26′ being planar sheet materials can be more easily located and sealed on the edges of the walls 16′a, b and side walls 24′a, b.

Mounting plate 36′, located inside the box 12′, has a curved shape, see FIG. 10(b). to lid 26 with opposing arc edges 38′a, b at ends of parallel arranged side edges 40′a, b. The plate holds the array of apertures 42′. Referring to FIG. 10(c), it can be seen that the mounting plate 36′ is formed in a flexible material which is planar. Each aperture 42′ is arranged at a height dependant upon the row it sits in. The outermost rows are at the greatest height. When the plate 36′ is located in the box 12′, it is bent to form an arcuate shape, see FIG. 10(b). Each aperture 42′ is sized to hold a pipette tip 14′ with the tips 14′ being directly radially inwards. The varying heights mean that the tops of the apertures 42′ are substantially in a plane which makes it easier to use arrays of pipettes.

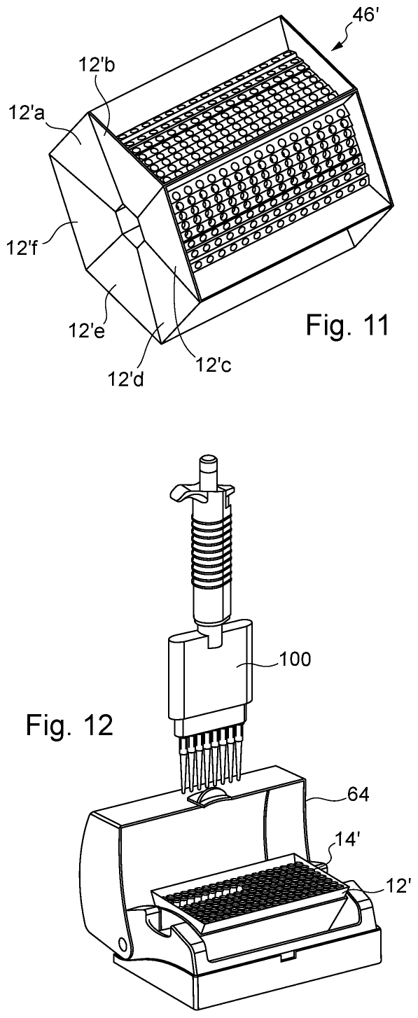

Referring now to FIG. 11 there is illustrated a cylindrical assembly 46′. Assembly 46′ comprises six boxes 12′a-e or magazines, but could have any number. When there are six boxes 12′a-e each sector is a 60 degree centre angle. The assembly 46′ provides a polygonal cylinder which has the same advantages and uses as for the assembly 46 described hereinbefore.

Magazine 10′ can be used in the mounting receptacle 64 shown in FIG. 9(a) to (g). This is illustrated in FIG. 12. An 8 multi-channel pipette 100 is also shown which lifts eight pipette tips 14′ at a time from the magazine 10′.

A principal advantage of the present invention is that it provides a laboratory ware magazine as a box which is a wedge shaped segment or ‘piece of pie’ shape, multiples of which can be combined to form a cylindrical assembly to provide a reduced footprint with larger numbers of laboratory ware such as pipette tips while isolating the pipette tips in smaller numbers to reduce the risk of contaminating large numbers of pipette tips.

A further advantage of the present invention is that it provides a laboratory ware magazine which can be replaced in a larger assembly of multiple magazines so that different laboratory ware can be used within a single assembly.

We claim:

1. A laboratory ware magazine comprising:
a box being substantially a sector of a cylinder: having first and second end walls being the sector shape enclosed between a perimeter and two radii at either end of that perimeter, first and second rectangular side walls with a width less than or equal to the radii and a length; and
a mounting plate with first and second opposing curved edges at ends of parallel arranged side edges, the plate including an array of apertures therethrough;
each of said apertures being configured such that an item of laboratory ware placed in the aperture is directed radially inwardly towards a tip of the sector.

2. A laboratory ware magazine according to claim 1 wherein the mounting plate is dimensioned to fit in the box.

3. A laboratory ware magazine according to claim 1 wherein the apertures are circular.

4. A laboratory ware magazine according to claim 3 wherein the apertures are shaped to each hold a pipette tip.

5. A laboratory ware magazine according to claim 1 wherein the perimeter is an arc and the cylinder has a circular cross-section.

6. A laboratory ware magazine according to claim 1 to 4 wherein the perimeter is a chord and the cylinder has a polygonal cross-section.

7. A laboratory ware magazine according to claim 1 wherein the box includes at least one lid with dimensions matching the perimeter of the end walls and the length of the side walls.

8. A laboratory ware magazine according to claim 7 wherein the lid is curved.

9. A laboratory ware magazine according to claim 7 wherein the lid is hinged to one of the side walls.

10. A laboratory ware magazine according to claim 7 wherein the lid is a slide fit to slide over the length of the box to provide an opening space in the box.

11. A laboratory ware magazine according to claim 7 to claim 9 wherein the lid is a flexible member.

12. A laboratory ware magazine according to claim 11 wherein the flexible member is a plastic film attached to the box.

13. A laboratory ware magazine according to claim 11 wherein the flexible member is a metal foil attached to the box.

14. A laboratory ware magazine according to claim 7 wherein the lid is sealed to the box.

15. A laboratory ware magazine according to claim 1 wherein the number of apertures in the mounting plate is selected from a group consisting of 96, 100 and 128.

16. (canceled)

17. A laboratory ware magazine according to claim 1 wherein a tip of the sector were the side walls meet, is removed and a rectangular face located between the side walls as a base for the box.

18. A laboratory ware magazine according to claim 1 wherein the laboratory ware magazine includes a mounting receptacle, comprising a rectangular member having a base to locate upon a work bench or the like; and a recess shaped to hold the box for all ends of the perimeter to be equidistant from a plane of the base.

19. (canceled)

20. A laboratory ware magazine according to claim 18 wherein the mounting receptacle includes a rotational mount configured to allow the box to rotate about the centre of the two radii.

21. A laboratory ware magazine according to claim 1 wherein a plurality of boxes are arranged to form a cylindrical assembly.

22. (canceled)

23. (canceled)

24. (canceled)

25. (canceled)

26. (canceled)

27. (canceled)

28. A laboratory ware magazine according to claim 21 wherein the cylindrical assembly includes end caps which affix to each box at the first and second end walls and an assembly receptacle being a substantially rectangular member having a base for locating upon a work surface, and a recess into which the cylindrical assembly is located.

29. (canceled)

30. (canceled)

31. (canceled)
